(19) United States
(12) Patent Application Publication
(10) Pub. No.: US 2007/0235295 A1
(43) Pub. Date: Oct. 11, 2007

(54) Apparatus having user input device with changeable indicia

(76) Inventors: Shubhra Verma, Bangalore (IN); Donald E. Brodnick, Cedarburg, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/398,248

(22) Filed: Apr. 5, 2006

(51) Int. Cl. H01H 13/72

(52) U.S. Cl. 200/5 A

(57) ABSTRACT

An apparatus, such as a medical equipment product, has an integral user input device with a plurality of manually actuatable keys representing a predetermined item of data or function specific to the associated product. The data is entered or function carried out by actuating the keys of the device. Visually perceptible indicia are associated with a selected plurality of the keys that are indicative of the item of data or function represented by the keys. E-ink may be used for to form the indicia. The visually perceptible indicia for the keys are established in a given language and can be altered from those of the given language to those in another language. This permits operation of the product with keys labeled in differing languages. The user input device may also have status indicators for the apparatus and/or input device with changeable indicia.

### FIELD OF THE INVENTION

This invention relates to an apparatus having a user input device, such as an integral keyboard, in which identifying indicia for keys or indicators can be changed. As an example, the indicia may be changed to change the language in which the indicia are expressed or to change the indicia from those used in one language to those used in another language.

### BACKGROUND OF THE INVENTION

In the growing international and global economy, it is desirable to have products that, once they are manufactured, may be sold in any number of different countries or regions with different languages. One field in which limitations in this respect are found is that of products having user interface devices, such as keyboards. Many electronic products are manufactured, sold, and operated worldwide. However, it is necessary for the user interface device of the products to be configured with operating components, such as keys or indicators, labeled in a language suitable for a local market.

With worldwide distribution of some electronic products requiring numerous different languages, problems in production management and inventory control are presented because a great deal of planning and cost is required to produce apparatus with interfaces in multiple languages and to maintain the proper supply levels of apparatus with properly labeled keyboards to meet the demand in the various markets. Also, once a product has been manufactured, configured, and shipped to a specific country, it may not be possible to shift that product to another country because the product interface is in a language different from that used in the new destination. Also, if a person desiring to operate a product in a given country or region is not fluent in that country/region's language, he/she will be less capable, or incapable, of operating the product because the interface has been labeled in the language of the given country and not in one in which the operator is fluent. Improper operation of the product resulting from an unsuitably labeled interface or input component may cause injury or damage.

There exist electronic products with data entry and interface devices that comprise keys with interchangeable functions and corresponding labels. However, these have typically been limited to the use of “soft keys” as taught in U.S. Pat. Nos. 5,059,960 and 5,724,069. “Soft keys” generally refer to unmarked buttons, usually in proximity to the edge of a display in the interface device. Labels in the adjacent portion of the display indicate the current functions of the buttons. As the functions of the buttons change, the labels in the display are changed.

However, soft keys are limited in their ability to address the problem noted above because of their need to be proximally located to an edge of a display so that most products can support only a small number of soft keys. The small number is much fewer than the required 30-80 keys that are necessary for the full QWERTY style keyboard often used as a user interface or input device. Furthermore, the soft key solution does not address the need for a user input device capable of supporting multiple languages for use on electronic devices that do not have a visual display system with available space.

An alternative to the soft key approach is shown in U.S. Pat. No. 5,459,776 that describes a telephone set having a pressure sensitive overlay mounted above the display rather than at its edge. A pressure sensitive means, such as a touch screen, is commonly used in many data entry devices. The underlying display displays input locations and values while the pressure sensitive overlay correlates the location of the pressure applied by the user to an underlying display region, thus providing a user input device with the capability to change the data entry values, labels, or locations. But similar to the soft key approach, the technique of this patent is suitable for a device having a small number of data entry locations.

U.S. Pat. No. 5,818,361 shows a computer keyboard in which certain keys include a small liquid crystal display (LCD) or other type of display. The function of the certain keys can be changed and when the function of the key changes, the display also changes. Published U.S. Patent Application No. 2002/0149568 shows a computer keyboard in which the functions of the keys remains the same as a liquid crystal display for the keys change.

### SUMMARY OF THE INVENTION

For the foregoing reasons, it would be desirable to have products having a user data entry interface or input device in which the alpha-numeric or other indicia for the keys or buttons representing a predetermined item of data or function of the keyboard may be selected to any one of a number of languages or to the characters of different languages and that the selection may be easily and simply performed by the user rather than the manufacturer. It would also be desirable to such an interface or input device in the changeable indicia would remain in a visually perceptible condition even when power to the interface or device is turned off.

Briefly, an embodiment of the present invention is directed to apparatus having an integral user input device. The input device may comprise an alpha-numeric keyboard but the invention is applicable to devices having more or fewer keys than a typical keyboard. Each of the keys of the user input device represents a predetermined item of data or function of the device specific to an associated product, such as a piece of medical equipment, in which the device is incorporated to form the apparatus. The data is entered or function carried out by actuating, typically by depressing, the keys of the device. The device may be of the membrane type or full travel push button type. Or, a touch screen may be employed in the keyboard. At least a selected plurality of the keys have means for providing a visually perceptible indicium for each of the selected keys comprising an alpha-numeric or other character or characters indicative of the item of data or function represented by the keys and specific to the associated product.

A control, such as an appropriately programmed microprocessor in the product, establishes the indicia of the keys in a desired language, including changing to the character or characters of a desired language, if necessary. The indicia for the selected plurality of keys may be altered from a previously established language or from the character or characters of such language to a different language or the differing alpha-numeric characters of another language, thereby to permit operation of the product with keys labeled in different languages.

The indicia may be formed in an electronic ink or “e-ink” film or using liquid crystal displays. The use of e-ink allows the indicia to be maintained even when the power to the device is turned off. The visually perceptible indicia may be located on or adjacent the selected plurality of keys.

The product user input device may also contain additional changeable indicia or text fields that are not associated with keys of the input device. These may comprise status indications for the input device, such as “CapsLock”, “NumLock”, or “ScrollLock” or information pertinent to the operation of the product, such as “PowerOn”, “BatteryLow”, NetworkActive”, and the like.

### BRIEF DESCRIPTION OF THE DRAWINGS

FIG. 1 is a view an embodiment of apparatus of the present invention comprising of a product incorporating a interface device with changeable indicia.

FIG. 2 is a detailed view of the interface portion of the apparatus.

FIG. 3 is a further detailed view of the interface portion of the apparatus.

FIG. 4 is a sectional view along line 4-4 of FIG. 2.

FIGS. 5a and 5b diagrammatically show the principles of electronic ink technology that may be used in the apparatus of the present invention.

FIG. 6 is a diagram of control circuitry suitable for use with the product of the present invention.

FIG. 7 is a view, similar to FIG. 4 showing a modification.

FIG. 8 is a fragmentary view of another modification.

FIG. 9 is a fragmentary view of a further embodiment.

FIG. 10 is a detailed view of yet another embodiment.

FIG. 11 is a detailed view of still another embodiment of the present invention.

### DETAILED DESCRIPTION

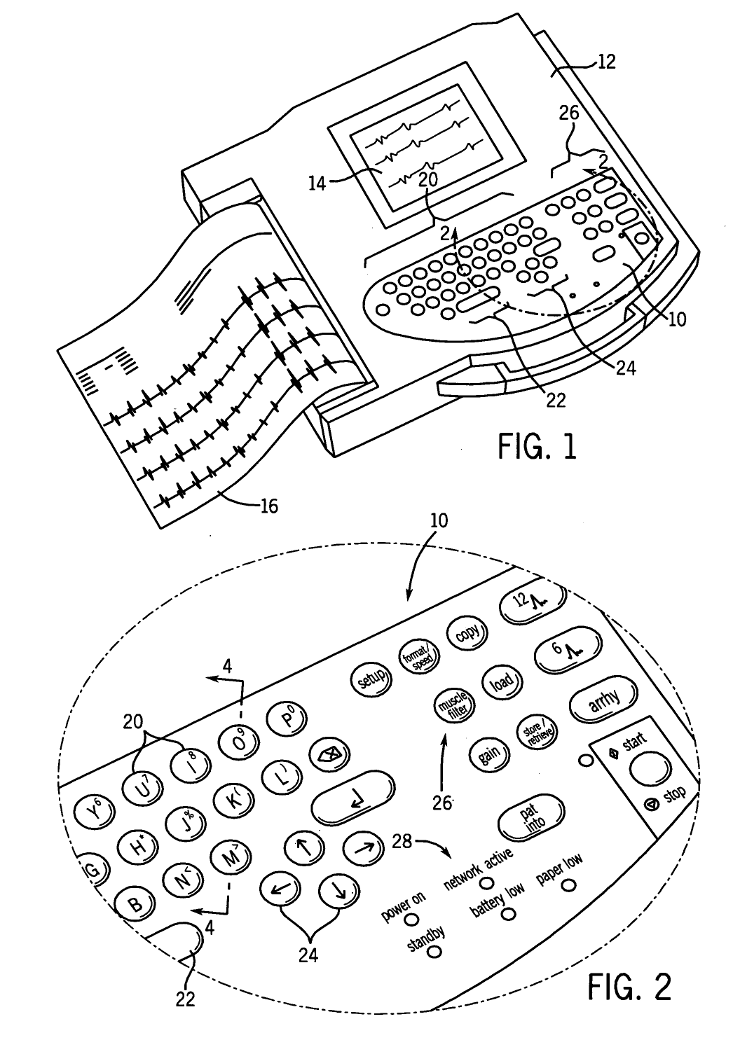

FIG. 1 shows an embodiment of the apparatus of the present invention incorporating a user input device in the form of an integral keyboard 10 in product 12. The product is typically shown as an electrocardiograph. Electrocardiograph 12 is connected to a patient by electrodes and leads (not shown). The electrical phenomena accompanying the physiological functioning of the heart is shown in display 14. It may also be provided as an electrocardiogram on paper strip 16. User input device 10 is used to enter data into electrocardiograph 12, control the functioning of the electrocardiograph, and display information relating to its operation and status.

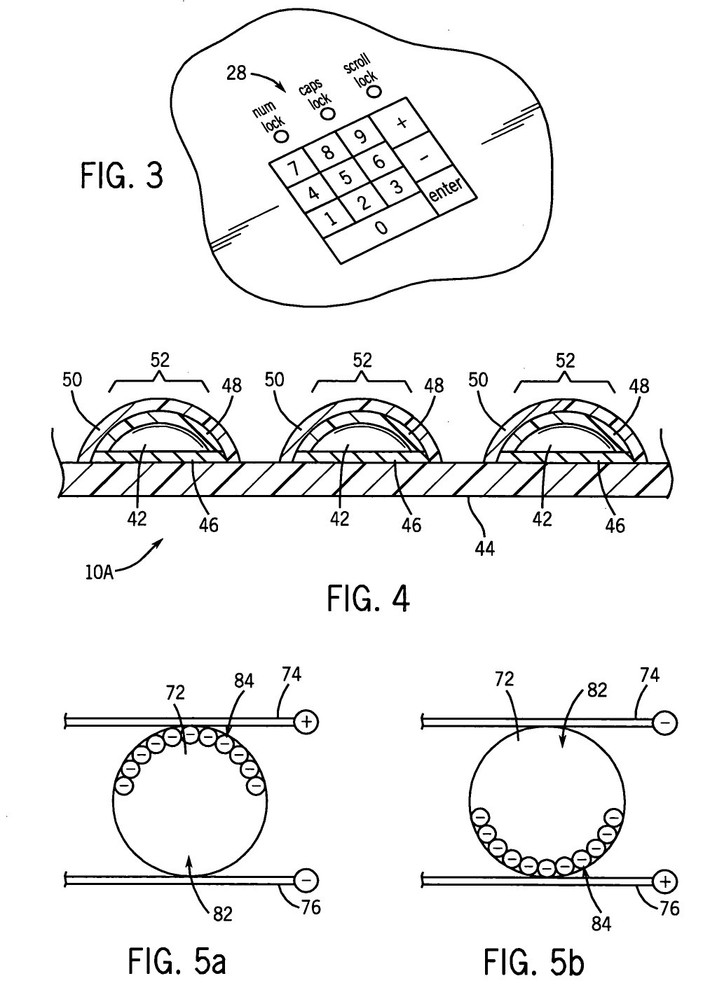

A portion of user input device 10 is shown in greater detail in FIG. 2. The keyboard shown there incorporates a plurality of pressure responsive keys for allowing data to be entered into electrocardiograph 12 and for controlling the functioning of the electrocardiograph. Specifically, keyboard 10 includes a plurality of alpha-numeric keys 20 which may comprise a QWERTY keyboard, along with ancillary keys, 22, such as a space key, shift key, numbers key, and the like. While FIGS. 1 and 2 show a keyboard with combined alpha-numeric keys 20, it will be appreciated that a separate numeric keypad as shown in FIG. 3 may be provided, if desired. Keyboard 10 typically also includes a plurality of cursor control keys 24 for moving a cursor in display 14. Function control keys 26 that, for example, control the aspects of electrocardiograph 12 relating to changing the number of ECG leads from which data is to be collected and displayed (6 or 12), the formatting of the reported data, muscle movement artifact filtering, arrhythmia detection, patient information, and the like are also provided in keyboard 10. In addition to the data entry and function control keys, keyboard may also have indicators 28 of product status, such as “PowerOn”, “Standby”, etc. or of user interface status, such as “CapsLock” or “NumLock” as shown in FIG. 3.

As can be seen from FIGS. 1 and 2, each of the keys and indicators of keyboard 10 has associated therewith an indicium, such as a letter or number, an item of data, or a function such as “format/speed” represented by a key. These indicia enable a clinician to input desired information into electrocardiograph 12 and control its operation.

As noted above, these indicia are usually specific to given particular language. This has required the manufacture and stocking of a large number of properly labeled apparatus for various markets in the global economy. For example, while keyboard 10, labeled with letters from the Latin alphabet may accommodate data entry for a number of languages, such as English and Spanish, the labeling of function keys 26 and indicators 28 that employ complete words will differ among languages. Other languages, such as Russian and Greek, employ alphabets that differ from the Latin alphabet. Still other languages, such as Chinese and Japanese do not employ alphabetical letters, but rather use characters. Also as noted above, a feature of the present invention is to provide an apparatus with a user input device in which indicia for the keys and indicators can be changed so as to be suitable for use in particular country/region or by a particular user.

FIG. 4 is a cross sectional view taken along the line 44 of FIG. 2 and depicts an embodiment of the present invention 10A in which the keys comprise a plurality of tactilely responsive switches 42 which may be membrane pressure operated switches. Membrane switches 42 are mounted on a base or substrate 44 that typically includes a printed circuit connection board for switches 42. The membrane switches 42 translate the tactile actuation by the user to an electrical signal to be provided to product 12 via conductors 46 on the printed circuit connection board. The electrical signal provided by the actuation comprises the entry of a predetermined item of data, such as a character or number, or a predetermined function into product 12.

For operation of keyboard 10, it is necessary to provide an indicium for each of the keys indicating to the operator the data or function attributable to each of the keys or the nature of the indicators 28. FIG. 4 shows a flexible electronic ink film 48 of the type shown in FIG. 5 applied over switches 42 to provide indicia 52 for each of the switches. An electronic ink film would similarly be applied adjacent indicators 28. Electronic ink film 48 may be covered by a flexible protection layer 50, if desired, to lend durability and a longer service life to keyboard 10.

Flexible film 48 may utilize thin film transistor (TFT) technology in which plastic transistors are printed on to a thin film of plastic for use in controlling a layer of pigmented microcapsules that are changed from a first color to a second color and back by using small electrical charges controlled by the plastic transistors. A form of electronic ink is shown in FIG. 5, that diagrammatically depicts electronic ink microcapsule 72 sandwiched between two layers of thin film transistors 74 and 76 that are charged with a positive or negative polarity, respectively. Microcapsule 72 is filled with a blue or similarly colored ink 82, within which white, electronically charged, balls, chips, or similar elements 84 are suspended.

In the example shown in FIG. 5, negatively charged balls 84 react to the charges of thin film transistors 74 and 76. As depicted in FIG. 5a, thin film transistor layer 74 has a positive charge that attracts the white balls 84 to the top of microcapsule 72, thus making it appear white when viewed from the top. Conversely, in FIG. 5b, thin film transistor layer 76 has a positive charge and the white balls 84 are attracted towards thin film transistor 76, thus exposing the blue ink 82. This makes the microcapsule 72 appear blue when viewed from the top. By employing a plurality of the microcapsules 72 in the layer, as operated by the thin film transistor layers, indicia for the keys and indicators may be formed from the microcapsules contained in film 48. Thin film transistor layers 74 and 76 can be operated by conductors in printed circuit board 46. Producers of electronic ink products currently include the Xerox Corp., and E-Ink Corp.

Advantages of electronic ink technology include a superior look featuring high contrast, a wide viewing angle, and legibility in low light. Indicia 52 formed from electronic ink consume no power except when the indicia are being changed and allowing the indicia to remain in a visually perceptible form when the power is turned off.

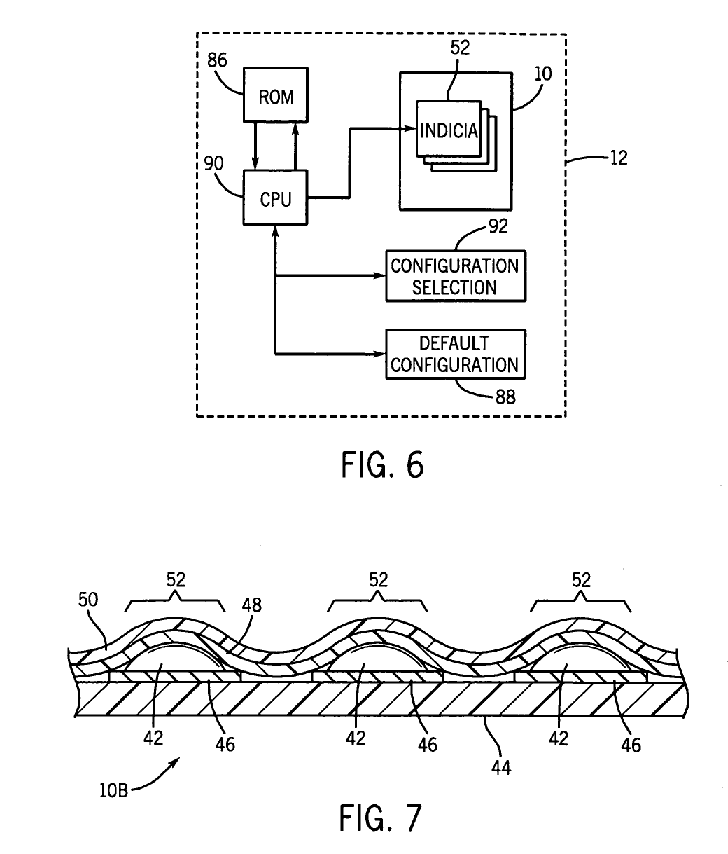

FIG. 6 depicts a general block diagram of circuitry for use with user input device 10 incorporated in the present invention. The circuitry controls the thin film transistors in electronic ink film 48 to generate indicia 52. The circuitry would typically be found in product 12 and use components already present in product 12 to carry out other functions or operations of the product. The circuitry includes a read only memory (ROM) 86 containing data for operating the transistors to provide indicia 52 proximate to each switch 42 and indicator 28 in one of a plurality of languages. The circuitry may have a predetermined default configuration means 88 that provides instructions to CPU 90 and memory 86 to select one of the plurality of languages as a default language for indicia 52 of user input device 10. The user selects a new configuration for the selected configuration for user input device 10 using configuration selection means 92 through appropriate operation of user input device 10 such as a predetermined sequence of keystrokes.

FIG. 4 depicts an embodiment of the present invention in which flexible electronic ink film 48 is applied over the individual keys of the user input device. As shown in FIG. 7, electronic ink film 48, and if desired protective film 50, can also be applied over all or a portion of user input device 10B in the form of a membrane. This facilitates cleaning of device 10B as by wiping with a cloth or other suitable cleaning product.

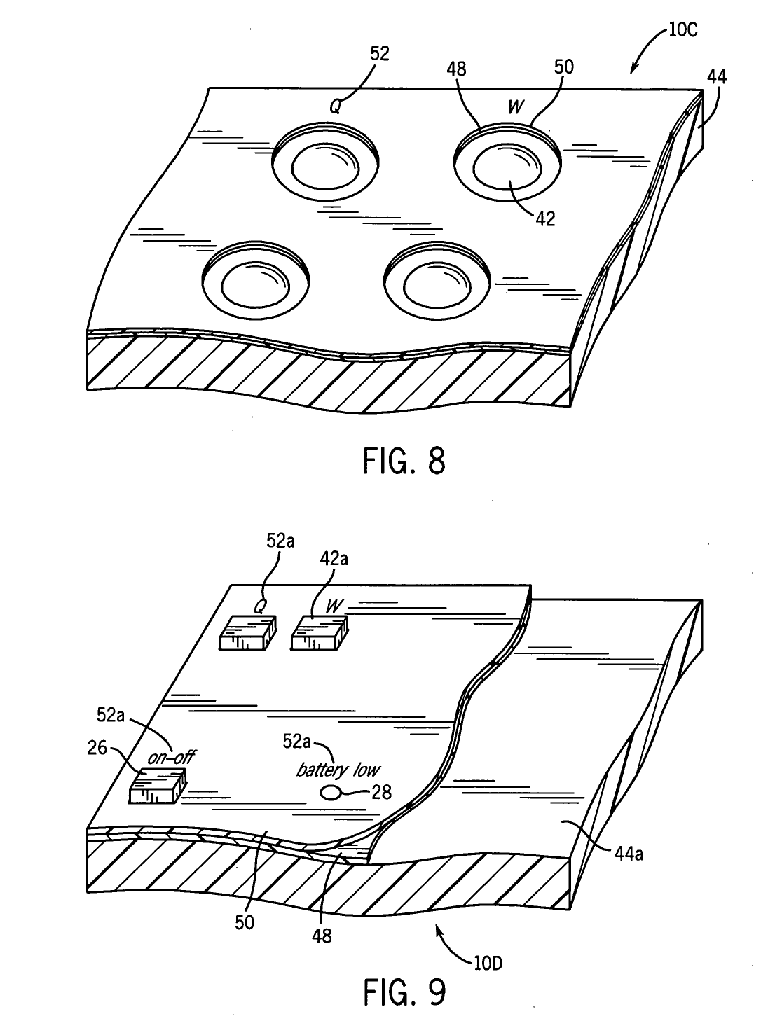

As shown in FIG. 8, it is also possible for film 48 to have the portions of the display removed, thereby allowing the plurality of switches 42 of user input device 10C to be exposed for the user to manipulate. Thus, electronic ink film 48 surrounds the plurality of keys on user input device 10C and indicia 52 may be provided above or below the exposed switches 42. The arrangement of FIG. 8 should prolong the life of film 48 since flexing of the film is avoided. Electronic ink film 48 may generally be in the form of a membrane covering base 44, as shown in FIG. 7, or may comprise individual elements associated with individual keys and indicators.

FIG. 9 shows user input device 10D having keys in the form of push button switches 42a mounted on an appropriate substrate 44a, such as a printed circuit board. User input device 10D resembles a conventional keyboard and switches 42a provide the enhanced tactile feedback preferred by many keyboardists. Film 48 containing the electronic ink for indicia 52a, and protective layer 50 if used, may be in the form of a template that fits over the keys in the manner shown in FIG. 9.

In embodiments of the invention, such as those shown in FIGS. 8 and 9, it will be appreciated that default alpha-numeric or other characters may be printed, or otherwise placed, directly on the keys formed by switches 42, 42a or the indicators 28 and indicia 52a used to provide characters in another language suitable for a particular country, region, and/or user.

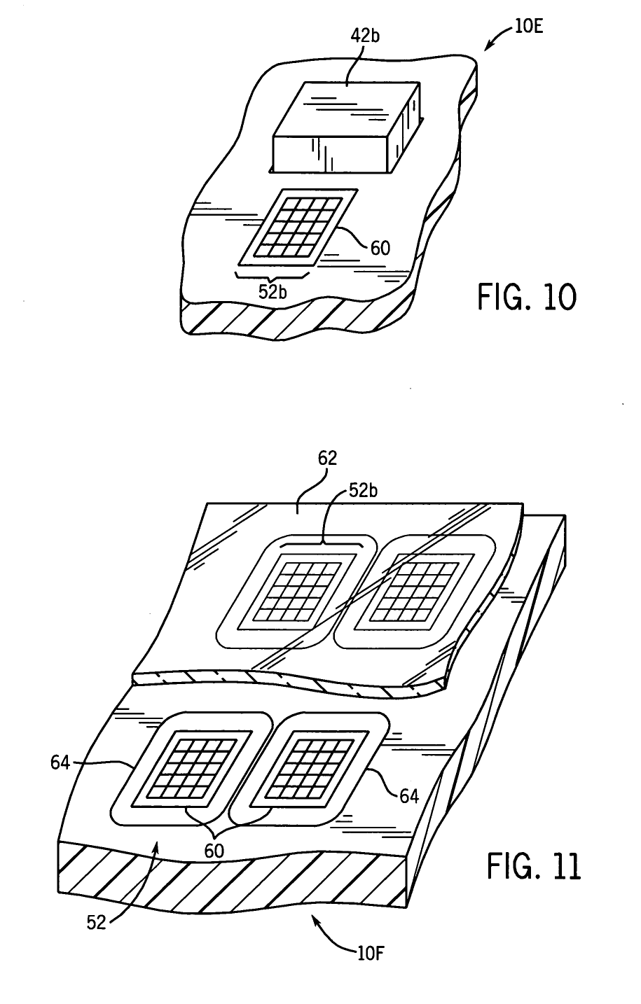

In addition to the use of electronic ink to provide indicia 52 for user interface device 10, liquid crystal display (LCD) technology may also be used. FIG. 10 shows an embodiment of the invention using a liquid crystal display 60 to create changeable key indicia 52b for key switch 42b in the context of a keyboard 10E of the type shown in FIG. 9. An LCD could also be used with user input devices of the type shown in FIGS. 2, 3, 7 and 8, and operated by circuitry similar to that shown in FIG. 6 to alter the color of various segments of liquid crystal display 60 to form characters or other indicia 52b.

It will be appreciated that in embodiments of the invention, such as those shown in FIGS. 8, 9, and 10, a permanent, default indicator may be placed on the keys, themselves.

FIG. 11 shows a further embodiment of the present invention comprising an electronic display such as an LCD 60 or other display of similar construction forming indicia 52b with a touch sensitive overlay 62 superimposed on top of the display 60. User interface device 10F will be defined and projected by the display 60 which may be viewed through the transparent touch sensitive overlay 62 by the user. LCD 60 is mounted on a suitable substrate to depict a user input device as a standard keyboard, by defining the outlines 64 of a plurality of keys. A portion of touch sensitive overlay 62 will correlate with the depicted form of the keyboard. Touch sensitive overlay 62 may typically be a pressure responsive touch sensitive overlay, but it is understood that the touch sensitive overlay may operate using many other techniques such as, but not limited to, capacitive sensing, heat detection, or relative position detection.

Upon operation, each discrete location or key 64/indicator 28 of the depicted keyboard will display a changeable indicia in LCD 60 indicative of the data or function that will be entered when the superimposed portion of touch screen 62 is actuated. The content of indicia 52b formed by LCD 60 for the key or for an indicator 28 may be changed by the circuitry of FIG. 6.

While LCD's 60 are shown separately in FIG. 11 for ease of explanation, it will be appreciated that they may be incorporated in a unitary structure or layer, if desired.

It is recognized that other equivalents, alternatives, and modifications aside from those expressly stated, are possible and within the scope of the appended claims.

1. Apparatus comprising:
a product;
user input device integral with said product and having a plurality of keys and indicators, each of a plurality of keys of the device representing a predetermined item of data or function for the product, the data being entered or function being carried out by actuating the keys of the device;
a plurality of manually actuatable elements forming the keys of the device;
a plurality of elements forming visually perceptible indicators of the device;
indicia means associated with at least a selected plurality of said keys and/or indicators for providing a visually perceptible indicium for each of the selected keys indicative of the item of data or function represented by the keys and/or a visually perceptible indicium for the nature of each of the indicators;
means for establishing the visually perceptible indicia in a form for use in a given language; and
means for altering indicia for the selected plurality of keys and/or indicators from a form suitable for use in one language to a form suitable for use in another language.

2. The apparatus of claim 1 wherein said indicia means provide indicia comprising an alpha-numeric character or characters or comprise other character or characters.

3. The apparatus of claim 1 wherein said indicia means is applied to the keys of said device.

4. The apparatus of claim 3 wherein indicia means are individually applied to the keys of said device.

5. The apparatus of claim 3 wherein said indicia means is applied to the keys as a unitary structure.

6. The apparatus of claim 5 wherein said indicia means is applied as a membrane.

7. The apparatus of claim 1 wherein said indicia means provides the indicia proximate to said keys or indicators.

8. The apparatus of claim 7 wherein said indicia means forms a template about keys or indicators of said device.

9. The apparatus of claim 1 wherein said indicia means comprises electronic-ink means.

10. The apparatus of claim 9 wherein said electronic ink means comprises an electronic ink film.

11. The apparatus of claim 10 wherein said electronic ink film is placed on said keys.

12. The apparatus of claim 10 wherein said electronic ink film covers a plurality of said keys.

13. The apparatus of claim 10 wherein said electronic ink film is placed in proximity to said keys or indicators.

14. The apparatus of claim 13 wherein said keys bear permanent indicia.

15. The apparatus of claim 1 wherein said indicia means is electrically operable and said indicia means maintains said indicia in visibly perceptible form when the electrical power is off.

16. The apparatus of claim 9 wherein said electronic ink means is electrically operable and maintains said indicia in visually perceptible form when the electrical power is off.

17. The apparatus of claim 1 wherein said indicia means comprise liquid crystal display means.

18. The apparatus of claim 17 wherein said liquid crystal display means is positioned proximate to said keys or indicators.

19. The apparatus of claim 18 wherein said keys bear permanent indicia.

20. The apparatus of claim 17 wherein said liquid crystal display means defines keys of said device and wherein said liquid crystal display means is covered with a touch screen.

21. The apparatus of claim 1 wherein said means for altering said indicia comprise part of said product.

22. The apparatus of claim 1 wherein said user input device comprises a keyboard.

23. The apparatus of claim 1 wherein said product comprises medical equipment.

24. The apparatus of claim 23 wherein said means for altering said indicia comprise part of said product.

25. An improved apparatus comprising:
a medical equipment product;
a keyboard integral with said product and having a plurality of keys and indicators, each of the plurality of keys of the keyboard representing a predetermined item of data or function for the medical equipment product, the data being entered or function being carried out by actuating the keys of the keyboard;
indicia means associated with at least a selected plurality of said keys and/or indicators for providing a visually perceptible indicium for each of the selected keys indicative of the item of data or function represented by the keys and a visually perceptible indicium for the nature of each of the indicators;
means for establishing the visually perceptible indicia in a character or characters for use in a given language; and
means for altering indicia for the selected plurality of keys and/or indicators from a form suitable for use in one language to a form suitable for use in another language, thereby to permit operation of the medical equipment product with keys and indicators labeled in different languages.
